(19) United States
(12) Patent Application Publication
(10) Pub. No.: US 2009/0142529 A1
(43) Pub. Date: Jun. 4, 2009

(54) Volatile liquid loadable porous metal or ceramic container and manufacturing method

(75) Inventors: Tien-Yin Chan, Sinshih Township (TW); Chin-Sheng Lee, Sinshih Township (TW); Chia-Liang Chen, Sinshih Township (TW); Yu-Che Huang, Sinshih Township (TW); Zhe-Yong Wu, Sinshih Township (TW)

Correspondence Address: Far East University, P.O. Box No. 6-57, Junghe, Taipei, 235, TW

(73) Assignee: Far East University, Sinshih Township (TW)

(21) Appl. No.: 11/987,297

(22) Filed: Nov. 29, 2007

(51) Int. Cl. B32B 1/08; B29D 23/00

(52) U.S. Cl. 428/36.5; 164/23; 264/44

(57) ABSTRACT

A volatile liquid loadable porous metal or ceramic container and manufacturing method thereof provided with a structural body formed by metal or ceramic sintering and provided with breathable pores, which extend from an outer surface of the structural body to the interior of the structural body, and the breathable pores form spaces to transport or/and store liquid. The manufacturing method includes: a. taking a low temperature volatile material as the core; b. completely covering the aforementioned core with metal or ceramic powder in the predetermined mold; c. controlling compactness of the metal or ceramic powder; d. sintering of the core at a temperature higher than the vaporization temperature to cause gaseous effusion of the core; e. taking off the predetermined mold after completing sintering.

### BACKGROUND OF THE INVENTION

(a) Field of the Invention

The present invention relates to a liquid loadable porous metal or ceramic container and manufacturing method thereof, in which metal or ceramic powder is mulled with a pore-forming agent and packed to cover a volatile core, and high temperature combustion is used to transform the core into a gaseous state, thereby producing a structural body having breathable pores.

(b) Description of the Prior Art

Volatile liquids, such as perfume, aromatics, and the like, are usually filled in bottle containers, and spraying or natural volatilization means are used to disperse the liquid in the air and achieve an aromatic effect. However, filling volatile liquids in bottle type containers is not suitable for carrying small amounts, and bottle type filling means is also not the optimum method for locations requiring small amounts and long-acting volatility.

Heretofore, using articles having porosity characteristics to form container spaces and to store volatile liquids to allow a slow natural release of the liquid are not found in the prior art. Moreover, at the present time, porous articles being able to be molded to form accessories or decorative articles during manufacture, as well as being able to provide dehumidifying effectiveness have not appeared in the prior art.

### SUMMARY OF THE INVENTION

The present invention primarily resolves unsuitability of volatile liquid loadable prior art containers for carrying small amounts and long-acting volatility, and unsuitability of the prior art containers to produce decorative accessories.

A liquid loadable porous metal or ceramic container of the present invention comprises a structural body formed by metal or ceramic sintering and provided with breathable pores. The breathable pores extend from the outer surface of the structural body to the interior of the structural body, and the breathable pores provide spaces to transport or/and store liquid.

Interior of the aforementioned structural body is provided with a hollow portion, and the breathable pores extend to the hollow portion.

The aforementioned structural body is provided with a plurality of layers, and the pore number of each of the layers gradually increases from the outer layer to the inner layer.

The present invention also provides a manufacturing method for a porous metal or ceramic container, comprising:

a. Taking a low temperature volatile material as the core;

b. Completely covering the aforementioned core with metal or ceramic powder in the predetermined mold;

c. Controlling compactness of the metal or ceramic powder;

d. Sintering of the core at a temperature higher than the vaporization temperature to cause gaseous effusion of the core;

e. Taking off the predetermined mold after completing sintering.

The aforementioned low temperature volatile material is either paraffin wax or a high polymer material.

A further manufacturing method of the porous metal or ceramic container of the present invention comprises:

a1. Mulling the metal or ceramic powder with a pore-forming agent;

b1. Injecting the mulled material of step al to form a first partial embryo;

c1. Taking a low temperature volatile material as a core;

d1. Injecting the mulled material from step al to form a second partial embryo, and using the second partial embryo and the first partial embryo to jointly cover the core;

e1. Degreasing and removing the pore-forming agent and the core;

f1. Sintering the first partial embryo and the second partial embryo.

The porous metal or ceramic container of the present invention also has use as a volatile liquid container, wherein the porous metal or ceramic container primarily uses capillarity to absorb and store volatile liquids, and enables dispersal of the volatile liquids from the pores of the porous metal or ceramic container.

The aforementioned volatile liquid provides an aromatic effect.

The aforementioned volatile liquid provides a mental stimulating effect.

The aforementioned volatile liquid provides a deinsectization effect.

The aforementioned volatile liquid provides a health care effect.

The porous metal or ceramic container of the present invention also provides a dehumidifying function, primarily using capillary adsorption of the porous metal or ceramic container to store water molecules from the air and realize dehumidifying effectiveness.

The present invention is provided with the following advantages:

1. Use of the capillary action of the porous structural body pore enables adsorption and storage of volatile liquids to form a storage space for volatile liquids, and enables long-acting slow release of the volatile liquids.

2. Uses the pores of the porous structural body to absorb moisture in the air, thereby achieving a dehumidifying function.

3. The structural body can be molded into different forms, such as ornaments to serve as personal accessories or for display purposes, and enable small amounts of a volatile liquid (such as perfume) to be carried on person and have long-acting dispersal effectiveness.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view depicting a structural body formed by sintering and provided with breathable pores according to the present invention.

FIG. 2 shows a schematic view depicting a structural body provided with an internal hollow portion according to the present invention.

FIG. 3 shows a schematic view depicting a structural body provided with a plurality of metal/ceramic layers, in which the number of breathable pores gradually increases progressively from the outer layer to the inner layer according to the present invention.

FIG. 4 shows a flow chart of a manufacturing method according to the present invention.

FIG. 5 shows a flow chart of a manufacturing method depicting sectional injection according to the present invention.

FIG. 6 shows a schematic view depicting joining of a first partial embryo to a volatile core by sectional injection means according to the present invention.

FIG. 7 shows a schematic view depicting the core covered by the first partial embryo and a second partial embryo according to the present invention.

### DETAILED DESCRIPTION OF THE PREFERRED EMBODIMENTS

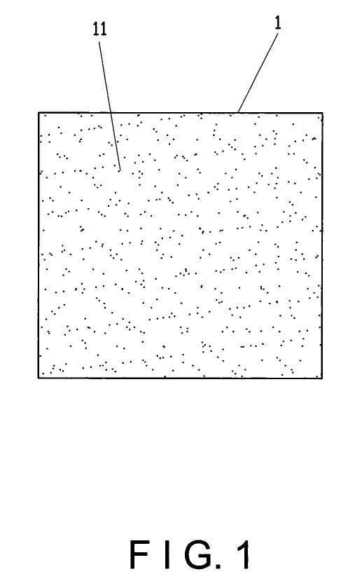

Referring to FIG. 1, which shows a first embodiment of the present invention, comprising a structural body (1) formed by metal or ceramic sintering and provided with breathable pores (11), which extend from an outer surface of the structural body (1) to the interior for the purpose of forming spaces to transport or/and store liquid, thereby enabling liquid to be absorbed into or released through the breathable pores (11).

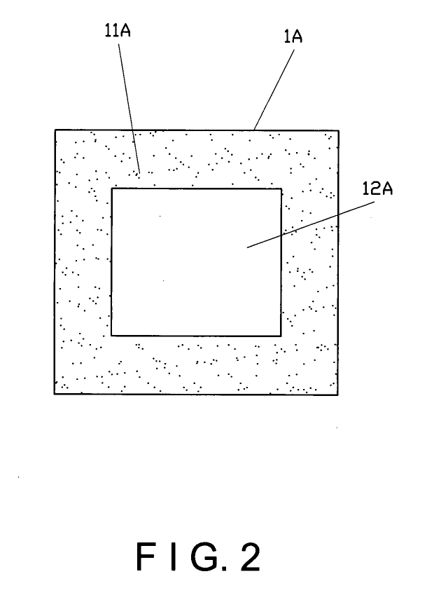

A second embodiment of the present invention provides a hollow portion (12A) interior of a structural body (1A, as depicted in FIG. 2, and the aforementioned breathable pores (11A) extend to the hollow portion (12A), thereby enabling liquid to be absorbed into the hollow portion (12A) through the breathable pores (11A), or enabling the liquid stored within the hollow portion (12A) to be outwardly released through the breathable pores (11A), slowing down the release rate of the liquid and holding the liquid for a long time.

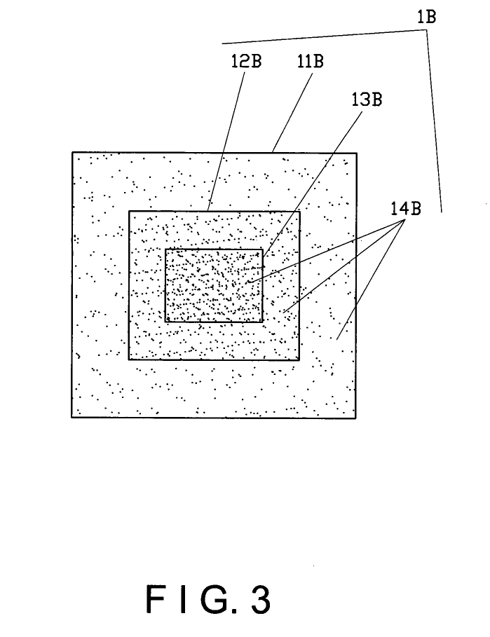

A third embodiment of the present invention comprises a structural body (1B) provided with a plurality of metal/ceramic layers (11B), (12B), (13B), as depicted in FIG. 3, wherein the number of breathable pores (14B) of each of the metal/ceramic layers (11B), (12B), (13B) gradually increase progressively from the outer layer to the inner layer, and capillarity is used to absorb liquid from the outer layer to the inner layer for storage thereat. Moreover, when in use, liquid in the inner layer is released layer by layer through the breathable pores (14B) towards the outer layer, slowing down the release rate of the liquid and holding the liquid for a long time.

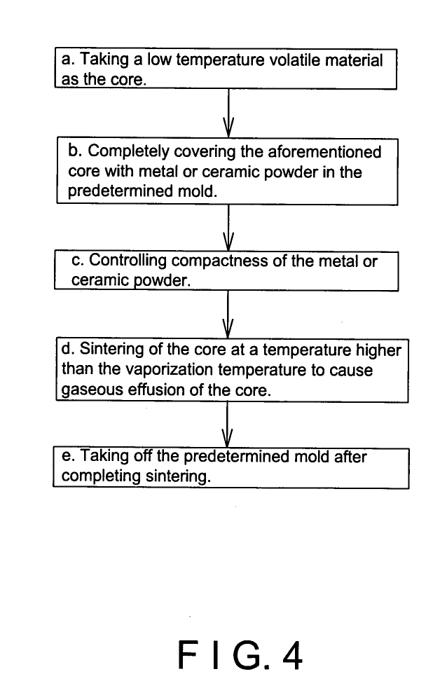

The present invention also provides a manufacturing method for a porous metal or ceramic container, as depicted in FIG. 4, comprising:

a. Taking a low temperature volatile material as the core; whereby the low temperature volatile material is used as the core, and the core is disposed in a predetermined mold.

b. Completely covering the aforementioned core with metal or ceramic powder in the predetermined mold;

whereby the metal or ceramic powder is packed within the predetermined mold to completely cover the aforementioned core.

c. Controlling compactness of the metal or ceramic powder;

whereby pressure is exerted on the metal or ceramic powder packed within the mold to control compactness of the metal or ceramic powder.

d. Sintering of the core at a temperature higher than the vaporization temperature to cause gaseous effusion of the core;

whereby sintering is carried out on the core and the metal or ceramic powder packed within the predetermined mold, and the sintering temperature is higher than the vaporization temperature of the core, thereby causing high temperature combustion and sublimation of the core into a gaseous state, whereupon the core effuses outside the metal or ceramic powder.

e. Taking off the predetermined mold after completing sintering;

whereby the predetermined mold packed with the completely sintered metal or ceramic powder is taken off. Accordingly, sintering of the metal or ceramic powder enables producing all kinds of finished products according to the form of the predetermined mold.

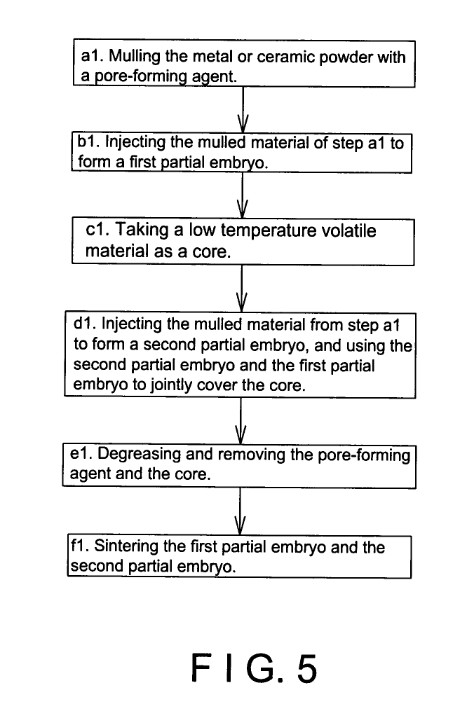

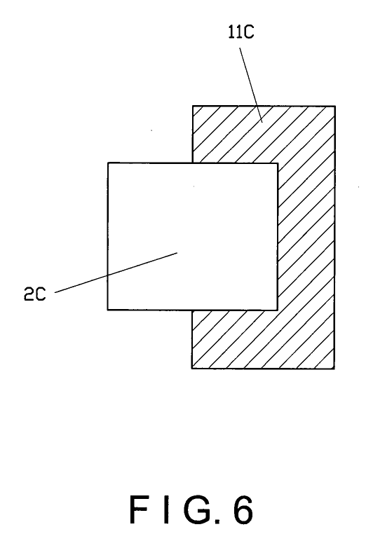

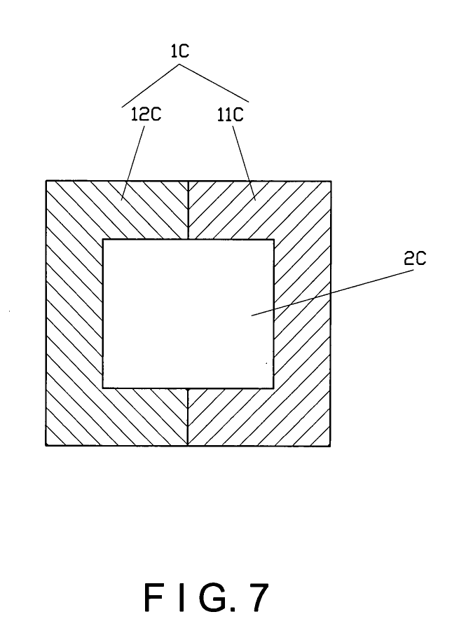

Furthermore, another embodiment of the manufacturing method for a porous metal or ceramic container of the present invention, as depicted in FIGS. 5, 6 and 7, comprises:

a1. Mulling the metal or ceramic powder with a pore-forming agent;

whereby the metal or ceramic powder and the pore-forming agent are mutually blended and mulled.

b1. Injecting the mulled material of step al to form a first partial embryo;

whereby the mulled material after completing blending of the metal or ceramic powder with the pore-forming agent of the aforementioned step a1 is used to form a first partial embryo (11C) by injection means.

c1. Taking a low temperature volatile material as a core;

whereby the low temperature volatile material is used as a core (2C), and the core (2C) is joined to the first partial embryo (11C).

d1. Injecting the mulled material from step al to form a second partial embryo (12C), and using the second partial embryo and the first partial embryo to jointly cover the core (2C);

whereby the completely blended mulled material of the metal or ceramic powder and the pore-forming agent from the aforementioned step al is used to form a second partial embryo (12C) by injection means, after which the second partial embryo (12C) is joined to the core (2C), and the first partial embryo (11C) and the second partial embryo (12C) are used to jointly cover the core (2C).

e1. Degreasing and removing the pore-forming agent and the core;

whereby degreasing of the first partial embryo (11C) and the second partial embryo (12C) is carried out, along with high temperature combustion causing vaporization, towards the outside of the first partial embryo (11C) and the second partial embryo (12C) of the pore-forming agent, mulled within the first partial embryo (11C) and the second partial embryo (12C), and the core (2C), covered by the first partial embryo (11C) and the second partial embryo (12C).

f1. Sintering the first partial embryo and the second partial embryo;

whereby high temperature sintering of the first partial embryo (11C) and the second partial embryo (12C) is carried out, causing the first partial embryo (11C) and the second partial embryo (12C) to sinter and form the porous structure (1C).

The porous metal or ceramic container of the present invention also has use as a volatile liquid container, wherein the porous metal or ceramic container primarily uses capillarity to absorb and store volatile liquids, whereby the volatile liquids can provide an aromatic, a mental stimulant, a deinsectization and a health care effect. For example: filling the porous metal or ceramic container with aromatic liquids, such as perfume, volatile oil or phytoncide, or filling with mental stimulant liquids, such as peppermint, green olein, or filling with deinsectization liquids, such as camphor wood oil, then the pores of the porous metal or ceramic container are used to diffuse the liquid, and diffusing of the aromatic, mental stimulant and deinsectization vapors through the breathable pores can be maintained for a long time. In addition, the porous metal or ceramic container can be used to produce all kinds of personal accessories, such as necklaces, bracelets, pendants and so on.

The porous metal or ceramic container of the present invention also has use as a volatile liquid container, wherein the porous metal or ceramic container primarily uses capillarity to absorb and store water molecules from the air, thereby providing a dehumidifying function. Moreover, when water stored by the porous metal or ceramic container has reached saturation, then internal moisture can be removed by heating means, thereby enabling the porous metal or ceramic container to be used again, and thus adding value to environmental protection.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A liquid loadable porous metal or ceramic container, comprising a structural body formed by metal or ceramic sintering and provided with breathable pores, the breathable pores extend from an outer surface of the structural body to the interior of the structural body, and the breathable pores form spaces to transport and store liquid.

2. The liquid loadable porous metal or ceramic container according to claim 1, wherein interior of the structural body is provided with a hollow portion, and the breathable pores extend to the hollow portion.

3. The liquid loadable porous metal or ceramic container according to claim 1, wherein the structural body is provided with a plurality of layers, and the number of pores of each of the layers gradually increase from the outer layer to the inner layer.

4. A manufacturing method for a porous metal or ceramic container, comprising:
a. taking a low temperature volatile material as the core;
b. completely covering the aforementioned core with metal or ceramic powder in the predetermined mold;
c. controlling compactness of the metal or ceramic powder;
d. sintering of the core at a temperature higher than the vaporization temperature to cause gaseous effusion of the core;
e. taking off the predetermined mold after completing sintering.

5. The manufacturing method for a porous metal or ceramic container according to claim 4, wherein the low temperature volatile material is either paraffin wax or a high polymer material.

6. A manufacturing method of a porous metal or ceramic container, comprising:
a1. mulling the metal or ceramic powder with a pore-forming agent;
b1. injecting the mulled material of step al to form a first partial embryo;
c1. taking a low temperature volatile material as a core;
d1. injecting the mulled material from step al to form a second partial embryo, and using the second partial embryo and the first partial embryo to jointly cover the core;
e1. degreasing and removing the pore-forming agent and the core;
f1. sintering the first partial embryo and the second partial embryo.

7. A porous metal or ceramic container having use as a volatile liquid container, wherein a porous metal or ceramic container uses capillarity to absorb and store volatile liquids, and the volatile liquids are dispersed from the pores of the porous metal or ceramic container.

8. The porous metal or ceramic container having use as a volatile liquid container according to claim 7, wherein the volatile liquids provide an aromatic effect.

9. The porous metal or ceramic container having use as a volatile liquid container according to claim 7, wherein the volatile liquids provide a mental stimulant effect.

10. The porous metal or ceramic container having use as a volatile liquid container according to claim 7, wherein the volatile liquids provide a deinsectization effect.

11. The porous metal or ceramic container having use as a volatile liquid container according to claim 7, wherein the volatile liquids provide a health care effect.
